(19) United States
(12) Patent Application Publication
(10) Pub. No.: US 2019/0289796 A1
(43) Pub. Date: Sep. 26, 2019

(54) MULCH SPREADER

(71) Applicant: DIMITRI WHITE, RIVER OAKS, TX (US)

(72) Inventor: DIMITRI WHITE, RIVER OAKS, TX (US)

(21) Appl. No.: 15/926,052

(22) Filed: Mar. 20, 2018

(51) Int. Cl. A01G 13/02; F04D 25/06

(52) U.S. Cl. CPC A01G 13/0287; B60P 3/30; F04D 25/0673

(57) ABSTRACT

The mulch spreader is a piece of lawn maintenance equipment that comprises a rotating mulch dispensing chute and a compressed air mulch loosening feature. The mulch spreader is wheeled and has a hopper that is suspended above the ground on wheel supports. A rotating dispenser chute is situated below the hopper and the rotating action of the chute spreads mulch over a wider area than a simply ‘drop chute’ would cover. The motor that causes the chute rotation is powered by a rechargeable battery contained within the mulch spreader. The same rechargeable battery also powers an air compressor. Air from the air compressor may be used to loosen mulch in the hopper and to expel mulch from the hopper via an optional external hose.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of lawn maintenance equipment, more specifically, a mulch spreader with a rotating dispensing chute and a compressed air mulch loosening feature.

### SUMMARY OF INVENTION

The mulch spreader is a piece of lawn maintenance equipment that comprises a rotating mulch dispensing chute and a compressed air mulch loosening feature. The mulch spreader is wheeled and has a hopper that is suspended above the ground on wheel supports. A rotating dispenser chute is situated below the hopper and the rotating action of the chute spreads mulch over a wider area than a simply ‘drop chute’ would cover. The motor that causes the chute rotation is powered via a rechargeable battery contained within the mulch spreader. The same rechargeable battery also powers an air compressor. Air from the air compressor may be used to loosen mulch in the hopper and to expel mulch from the hopper via an optional external hose.

An object of the invention is to spread mulch over an area.

A further object of the invention is to maximize the area that can be covered with mulch during each pass of the mulch spreader by utilizing a rotating dispenser chute on the mulch spreader.

Yet another object of the invention is to reduce the likelihood of clogging by passing compressed air through the hopper of the mulch spreader to loosen the mulch.

Another object of the invention is to use compressed air to expel mulch from a hose connection port, thus enabling the use of a hand-guided dispensing hose attached to the hopper of the mulch spreader.

These together with additional objects, features and advantages of the mulch spreader will be readily apparent to those of ordinary skill in the art upon reading the following detailed description of the presently preferred, but nonetheless illustrative, embodiments when taken in conjunction with the accompanying drawings.

In this respect, before explaining the current embodiments of the mulch spreader in detail, it is to be understood that the mulch spreader is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the mulch spreader.

It is therefore important that the claims be regarded as including such equivalent construction insofar as they do not depart from the spirit and scope of the mulch spreader. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a side view of an embodiment of the disclosure.

FIG. 2 is a front view of an embodiment of the disclosure.

FIG. 3 is a rear view of an embodiment of the disclosure.

FIG. 4 is a bottom view of an embodiment of the disclosure.

FIG. 5 is a detail view of an embodiment of the disclosure showing air flow and mulch flow.

FIG. 6 is a schematic representation of a portion of the electrical subsystem according to an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

As used herein, the word “or” is intended to be inclusive. As used herein, the word “control” is intended to include any device which can cause the completion or interruption of an electrical circuit; non-limiting examples of controls include toggle switches, rocker switches, push button switches, rotary switches, electromechanical relays, solid state relays, touch sensitive interfaces and combinations thereof whether they are normally open, normally closed, momentary contact, latching contact, single pole, multi-pole, single throw, or multi-throw.

Throughout this document references to ‘wire’, ‘wires’, or ‘wiring’ may describe and/or show a single conductor when, in fact, two conductors are required to power a subsystem. A convention used herein is to not show the common return conductor to which all electrical subsystems are connected; this common return conductor is a continuous electrical path and does not pass through any type of switch or other electrical component other than the possibility of passing through one or more connectors. As used herein, references to a motor spinning are intended to mean that some portion of the motor, such as a central spindle, are rotating; items that are described as being connected or coupled to the motor are intended to mean that the items are connected or coupled to the rotating portion of the motor such as the central spindle, unless they are describing the mounting of the motor within a housing.

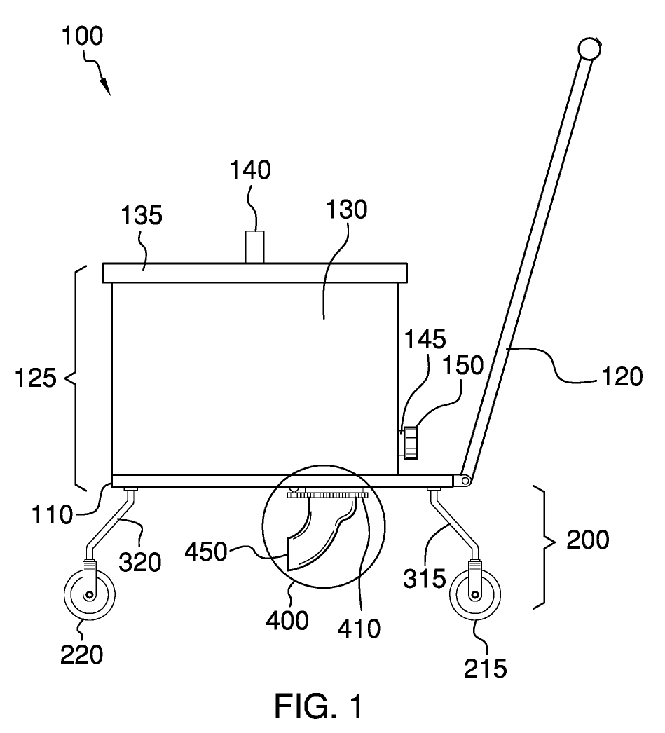

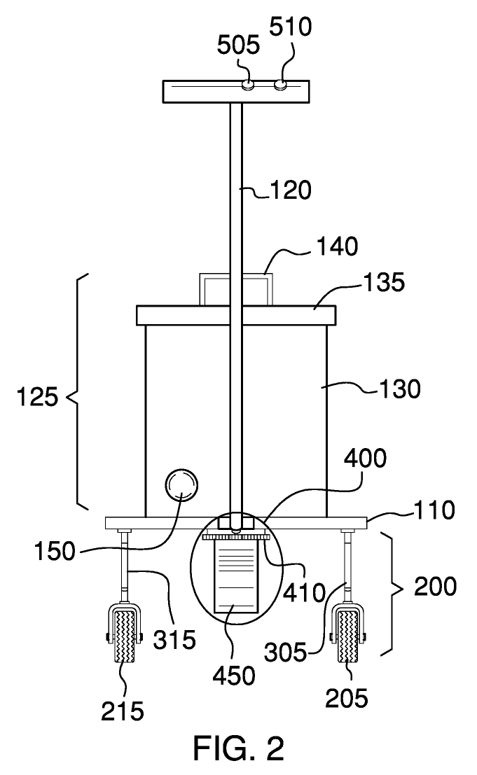

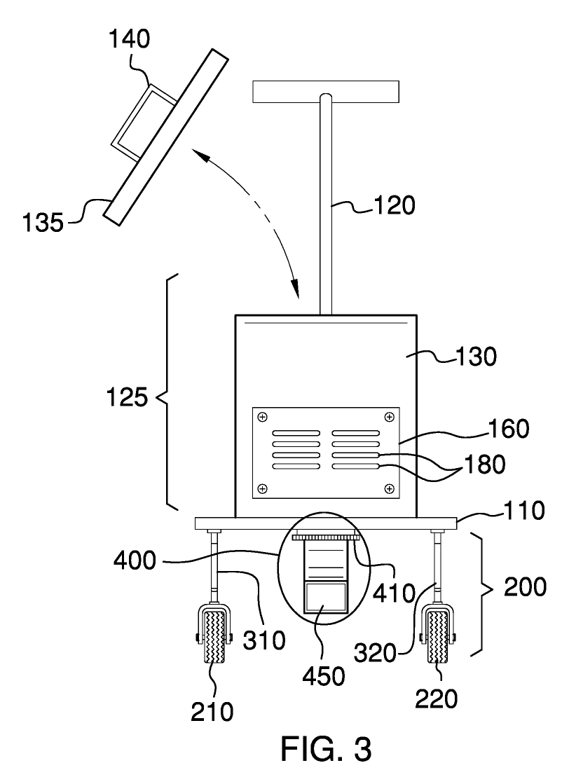

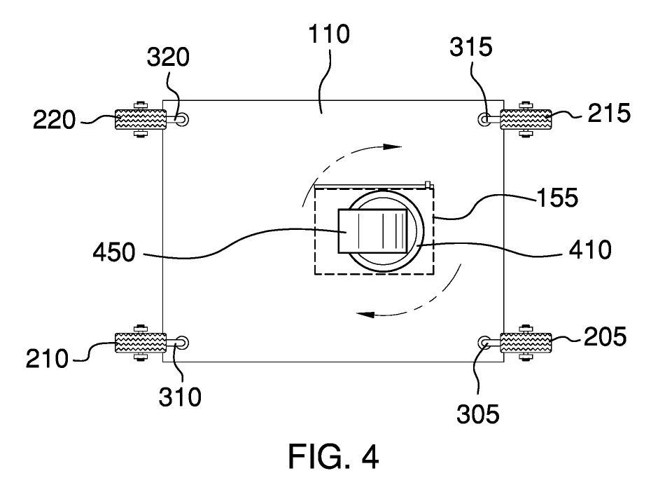

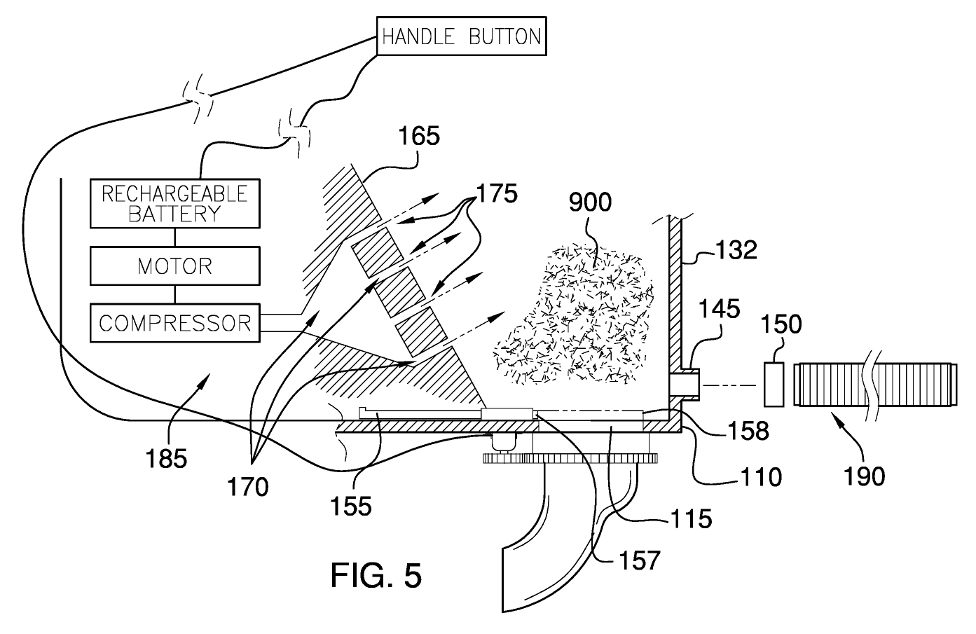

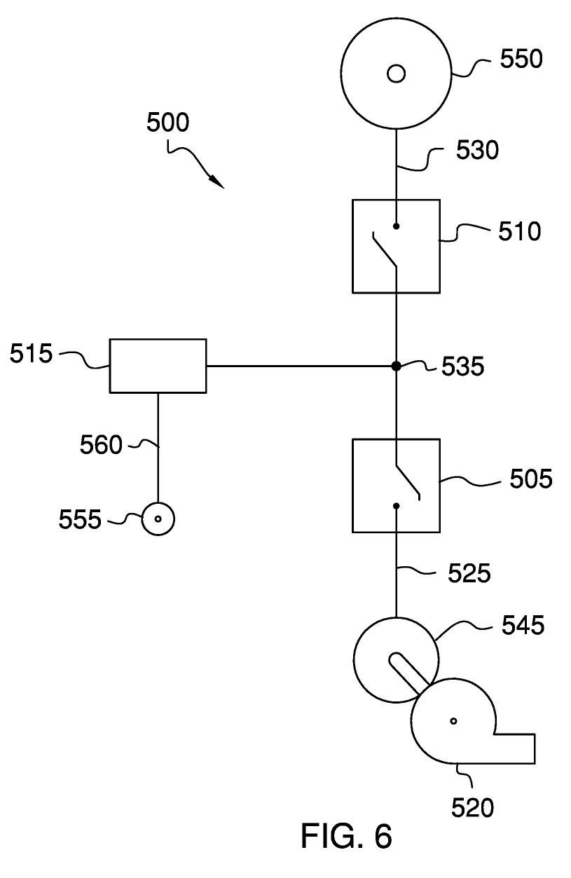

Detailed reference will now be made to a first potential embodiment of the disclosure, which is illustrated in FIGS. 1 through 6. The mulch spreader 100 (hereinafter invention) comprises a chassis 110, a handle 120, a mulch hopper subassembly 125, an under-chassis subassembly 200, a chute subassembly 400 and an electrical subsystem 500.

The chassis 110 serves as a base for the mulch hopper subassembly 125 and an attachment point for the under-chassis subassembly 200. Furthermore, the chute subassembly 400 is attached to the bottom side of the chassis 110. A hole in the chassis 115 allows mulch 900 to fall from a mulch hopper 130 into a chute 450.

The handle 120 allows an operator to pull the mulch spreader 100. A compressor button 505 and a chute rotation button 510 may be mounted on the handle 120 to make them more accessible to the operator. Depressing the compressor button 505 may cause a compressor motor 545 to spin. By causing the compressor motor 545 to spin, an air compressor 520 coupled to the compressor motor 545 turns and forces air into the mulch hopper 130. Depressing the chute rotation button 510 may cause a chute motor 550 to spin. When the chute motor 550 spins, the chute 450, which is coupled to the chute motor 550 via a bearing 410, will rotate. In some embodiments, the compressor button 505 and the chute rotation button 510 may be combined into a single button and this single button may cause both the compressor motor 545 and the chute motor 550 to spin.

The mulch hopper subassembly 125 comprises the mulch hopper 130, a hose connection 145, a removable cap 150, a trap door 155, an access panel 160, a plenum wall 165, a plenum 185 and a hopper cover 135. The mulch hopper 130 is a containment area for the mulch 900. The top of the mulch hopper subassembly 125 is open to allow the mulch 900 to be added to the mulch hopper 130. The opening at the top of the mulch hopper 130 may be covered when the hopper cover 135 is in place. The trap door 155 slides to allow or disallow the mulch 900 from leaving the mulch hopper 130. The hose connection 145 provides an attachment point for an external hose 190. The hose connection 145 is located on a side wall of the mulch hopper 130.

A central opening of the hose connection 145 allows the mulch 900 to pass from the interior of the mulch hopper 130 to an the external hose 190. The removable cap 150 covers the hose connection 145 when an the external hose 190 is not attached to the hose connection 145. In some embodiments, the removable cap 150 and the hose connection 145 may be threaded and the removable cap 150 may screw onto the hose connection 145. In some embodiments, the removable cap 150 may be attached to the mulch hopper 130 via a chain to prevent the removable cap 150 from being lost when the external hose 190 is attached to the hose connection 145.

The trap door 155 is located at the bottom of the mulch hopper 130 and provides a cover for the hole in the chassis 115. When it is desired that the mulch 900 fall out of the mulch hopper 130 then the trap door 155 is slid to an open position 157. When it is desired that the mulch 900 not fall out of the mulch hopper 130, then the trap door 155 is slid to a closed position 158. In some embodiments, the trap door 155 may be slid manually using a lever (not shown in the figures) that is accessible from outside of the mulch spreader 100. In some embodiments, the trap door 155 may be slid using an electromagnetic mechanism such as a solenoid (not shown) which is electrically wired to the chute motor 550 thereby sliding the trap door 155 to the open position 157 whenever the chute rotation button 510 is depressed and sliding the trap door 155 to the closed position 158 whenever the chute rotation button 510 is released. In some embodiments, the sliding of the trap door 155 may be assisted via one or more springs (not shown in the figures) mounted between portions of the trap door 155 and portions of the mulch hopper 130.

The access panel 160 is a removable hatch on the side of the mulch hopper 130 adjacent to the plenum 185. When the access panel 160 is removed it provides maintenance access to a rechargeable battery 515, the air compressor 520, and the compressor motor 545. In some embodiments, the access panel 160 may comprise one or more air inlets 180.

The plenum wall 165 is an interior side wall within the mulch hopper 130. The plenum wall 165, in combination with other side walls of the mulch hopper 130, forms the plenum 185. The plenum wall 165 separates the mulch 900 from the rechargeable battery 515, the air compressor 520, and the compressor motor 545. The plenum wall 165 comprises one or more air channels 170 and one or more air outlets 175.

The one or more air channels 170 direct the flow of air out of the air compressor 520 and into the mulch hopper 130. The one or more air channels 170 comprise pathways leading from the air compressor 520, through the plenum wall 165, and leading to the one or more air outlets 175. In some embodiments, a portion of the one or more air channels 170 may be molded into the plenum wall 165. In some embodiments, a portion of the one or more air channels 170 may comprise ductwork (not shown) leading from the air compressor 520 to the plenum wall 165.

The plenum 185 is an open space between a portion of a mulch hopper outer wall 132 and the plenum wall 165. The rechargeable battery 515, the air compressor 520, and the compressor motor 545 are mounted to standoffs located within the plenum 185.

The hopper cover 135 covers the mulch hopper 130 to keep the mulch 900 in the mulch hopper 130, to keep foreign debris from falling into the mulch hopper 130, and to help manage air pressure and air flow within the mulch hopper 130. In some embodiments, the hopper cover 135 may comprise one or more latches (not shown) to lock the hopper cover 135 in place. The hopper cover 135 comprises a hopper cover handle 140. The hopper cover handle 140 allows the hopper cover 135 to be easily removed.

The under-chassis subassembly 200 comprises a front left wheel 205, a rear left wheel 210, a front right wheel 215, a rear right wheel 220, a front left wheel support 305, a rear left wheel support 310, a front right wheel support 315 and a rear right wheel support 320. The front left wheel support 305, the rear left wheel support 310, the front right wheel support 315, and the rear right wheel support 320 hold the chassis 110 above ground level by at least the height of the chute subassembly 400. This assures that the chute 450 will be above ground level, will have sufficient room to rotate, and allows the mulch 900 to drop from the chute 450 and be deposited beneath the mulch spreader 100. The front left wheel 205 rotationally couples to the lower end of the front left wheel support 305. The front left wheel 205 may swivel around the lower end of the front left wheel support 305 to allow easier steering of the mulch spreader 100. The rear left wheel 210 rotationally couples to the lower end of the rear left wheel support 310. The front right wheel 215 rotationally couples to the lower end of the front right wheel support 315. The front right wheel 215 may swivel around the lower end of the front right wheel support 315 to allow easier steering of the mulch spreader 100. The rear right wheel 220 rotationally couples to the lower end of the rear right wheel support 320. The upper end of the front left wheel support 305 attaches to the chassis 110. The upper end of the rear left wheel support 310 attaches to the chassis 110. The upper end of the front right wheel support 315 attaches to the chassis 110. The upper end of the rear right wheel support 320 attaches to the chassis 110.

The chute subassembly 400 comprises the bearing 410 and the chute 450. The bearing 410 connects to the bottom side of the chassis 110 and surrounds the hole in the chassis 115. The chute 450 is rotationally connected to the bearing 410. The chute 450 rotates 360° around the bearing 410. The chute 450 is a conduit for the mulch 900 that is leaving the mulch hopper 130. Because the chute 450 rotates under the influence of the bearing 410 and the chute motor 550, the mulch 900 is spread over a larger area than that which would be covered by the mulch 900 simply falling from the hole in the chassis 115. In some embodiments, the chute 450 may be removable and replaceable thus enabling the use of other attachments that distribute the mulch 900 in a different pattern. In some embodiments, the chute 450 may accept attachments that modify how it performs.

The electrical subsystem 500 comprises the rechargeable battery 515, a recharging port 555, recharging port wiring 560, battery wiring 535, the compressor motor 545, the compressor button 505, compressor button wiring 525, the chute motor 550, the chute rotation button 510, chute rotation button wiring 530 and the air compressor 520. The rechargeable battery 515 is a control that allows or disallows the flow of electrical current to the air compressor 520. When the compressor button 505 is activated, electrical current flows from the rechargeable battery 515 to the compressor motor 545 causing the spindle of the compressor motor 545 to turn. The spindle of the compressor motor 545 is coupled to the air compressor 520 therefore activating the compressor button 505 causes air to be pumped into the mulch hopper 130. When the compressor button 505 is deactivated, electrical current stops flowing from the rechargeable battery 515 to the compressor motor 545 and therefore the spindle of the compressor motor 545 stops turning. This causes the air compressor 520 to cease blowing air into the mulch hopper 130. The rechargeable battery 515 comprises an energy storing device. The rechargeable battery 515 may provide an electrical potential difference to cause the energization of the chute motor 550 and the compressor motor 545. The rechargeable battery 515 may provide this electrical potential difference until such time as the rechargeable battery 515 becomes discharged, at which time the rechargeable battery 515 will require recharging from an external power source (not shown in the figures). The recharging port 555 comprises an electrical connector mounted on the mulch hopper 130 in such a way that it is accessible to an operator from the outside of the mulch hopper 130. In some embodiments, the internal connections to the recharging port 555 are accessible from within the plenum 185. An external charging adapter (not shown in the figures) may be plugged into the recharging port 555 for the purpose of recharging the rechargeable battery 515. The recharging port wiring 560 comprises a set of wires that conduct electrical current from the recharging port 555 to the rechargeable battery 515.

The battery wiring 535 comprises a set of wires that conduct electrical current from the rechargeable battery 515 to the compressor button 505 and to the chute rotation button 510.

The compressor motor 545 is mounted within the plenum 185 and is coupled to the air compressor 520. When electrical energy is applied to the compressor motor 545 the spindle of the compressor motor 545 turns and causes the air compressor 520 to move air from the one or more air inlets 180 to the one or more air outlets 175 via the one or more air channels 170. In some embodiments, air may flow into the plenum 185 via the one or more air inlets 180 and into the air compressor 520 directly from the plenum 185. The pressurized air pumped into the mulch hopper 130 causes the mulch 900 in the mulch hopper 130 to loosen and thus be less likely to clog. Additionally, if the trap door 155 is closed and the removable cap 150 has been removed, the flow of pressurized air out of the mulch hopper 130 via the hose connection 145 may carry the mulch 900 with it. Therefore, if the external hose 190 is attached to the hose connection 145 it may be possible to direct the placement of the mulch 900 outside of the mulch spreader 100 by aiming the external hose 190.

The compressor button 505 is a control that allows or disallows the flow of electrical current to the air compressor 520. When the compressor button 505 is activated, electrical current flows from the rechargeable battery 515 to the compressor motor 545 causing the spindle of the compressor motor 545 to turn. The spindle of the compressor motor 545 is coupled to the air compressor 520 therefore activating the compressor button 505 causes air to be pumped into the mulch hopper 130. When the compressor button 505 is deactivated, electrical current stops flowing from the rechargeable battery 515 to the compressor motor 545 and therefore the spindle of the compressor motor 545 stops turning. This causes the air compressor 520 to cease blowing air into the mulch hopper 130.

The chute motor 550 attaches to the bottom of the chassis 110 and is located in a position where it engages with the bearing 410. In some embodiments, the means of engaging the chute motor 550 and the bearing 410 may be gear teeth on the spindle of the chute motor 550 that engage with corresponding teeth on the bearing 410. In some embodiments, the means of engaging the chute motor 550 and the bearing 410 may be a belt (not shown) that runs around the spindle of the chute motor 550 and around a portion of the bearing 410. In some embodiments, the chute motor 550 may be mounted substantially within the plenum 185 with at least the end of the spindle of the chute motor 550 accessible under the chassis 110 and engaged with the bearing 410. In some embodiments, additional protective guards (not shown) may cover portions of the chute motor 550 or the bearing 410 to prevent accidental injuries.

The air compressor 520 is a mechanical air pump which sucks air in at the one or more air inlets 180, compresses the air, and expels pressurized air into the mulch hopper 130 via the one or more air channels 170 and the one or more air outlets 175. As previously described, air blown into the mulch hopper 130 by the air compressor 520 is used to loosen the mulch 900 in the mulch hopper 130 and to expel the mulch 900 via the hose connection 145.

With respect to the above description, it is to be realized that the optimum dimensional relationship for the various components of the invention described above and in FIGS. 1 through 6, include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A mulch spreader comprising:
a chassis, a handle, a mulch hopper subassembly, an under-chassis subassembly, a chute subassembly and an electrical subsystem;
wherein the chassis serves as a base for the mulch hopper subassembly and an attachment point for the under-chassis subassembly;
wherein the chute subassembly is attached to the bottom side of the chassis;
wherein a hole in the chassis allows mulch to fall from a mulch hopper into a chute.

2. The mulch spreader according to claim 1
wherein the handle allows an operator to pull the mulch spreader;
wherein a compressor button and a chute rotation button are mounted on the handle to make them more accessible to the operator;
wherein depressing the compressor button causes a compressor motor to spin;
wherein depressing the chute rotation button may cause a chute motor to spin;
wherein when the chute motor spins, the chute, which is coupled to the chute motor via a bearing, will rotate.

3. The mulch spreader according to claim 2
wherein the compressor button and the chute rotation button may be combined into a single button and this single button may cause both the compressor motor and the chute motor to spin.

4. The mulch spreader according to claim 3
wherein the mulch hopper subassembly comprises the mulch hopper, a hose connection, a removable cap, a trap door, an access panel, a plenum wall, a plenum and a hopper cover;
wherein the mulch hopper is a containment area for the mulch;
wherein the top of the mulch hopper subassembly is open to allow the mulch to be added to the mulch hopper;
wherein the opening at the top of the mulch hopper is covered when the hopper cover is in place.

5. The mulch spreader according to claim 4
wherein the trap door slides to allow or disallow the mulch from leaving the mulch hopper;
wherein the hose connection provides an attachment point for an external hose;
wherein the hose connection is located on a side wall of the mulch hopper;
wherein a central opening of the hose connection allows the mulch to pass from the interior of the mulch hopper to an the external hose;
wherein the removable cap covers the hose connection when an the external hose is not attached to the hose connection;
wherein the trap door is located at the bottom of the mulch hopper and provides a cover for the hole in the chassis;
wherein when it is desired that the mulch fall out of the mulch hopper then the trap door is slid to an open position;
wherein when it is desired that the mulch not fall out of the mulch hopper, then the trap door is slid to a closed position.

6. The mulch spreader according to claim 5
wherein the trap door is slid manually using a lever that is accessible from outside of the mulch spreader.

7. The mulch spreader according to claim 6
wherein the trap door is slid using an a solenoid which is electrically wired to the chute motor;
wherein the trap door slides to the open position whenever the chute rotation button is depressed;
wherein the trap door slides to the closed position whenever the chute rotation button is released.

8. The mulch spreader according to claim 7
wherein the access panel is a removable hatch on the side of the mulch hopper adjacent to the plenum;
where removing the access panel provides maintenance access to a rechargeable battery, the air compressor, and the compressor motor;
wherein the access panel comprises one or more air inlets.

9. The mulch spreader according to claim 8
wherein the plenum wall is an interior side wall within the mulch hopper;
wherein the plenum wall, in combination with other side walls of the mulch hopper, forms the plenum;
wherein the plenum wall separates the mulch from the rechargeable battery, the air compressor, and the compressor motor;
wherein the plenum wall comprises one or more air channels and one or more air outlets.

10. The mulch spreader according to claim 9
wherein the one or more air channels direct the flow of air out of the air compressor and into the mulch hopper;
wherein the one or more air channels comprise pathways leading from the air compressor, through the plenum wall, and leading to the one or more air outlets.

11. The mulch spreader according to claim 10
wherein the plenum is an open space between a portion of a mulch hopper outer wall and the plenum wall;
wherein the rechargeable battery, the air compressor, and the compressor motor are mounted to standoffs located within the plenum.

12. The mulch spreader according to claim 11
wherein the hopper cover covers the mulch hopper to keep the mulch in the mulch hopper, to keep foreign debris from falling into the mulch hopper, and to help manage air pressure and air flow within the mulch hopper;
wherein the hopper cover comprises a hopper cover handle;
wherein the hopper cover handle allows the hopper cover to be easily removed.

13. The mulch spreader according to claim 12
wherein the under-chassis subassembly comprises a front left wheel, a rear left wheel, a front right wheel, a rear right wheel, a front left wheel support, a rear left wheel support, a front right wheel support and a rear right wheel support;
wherein the front left wheel support, the rear left wheel support, the front right wheel support, and the rear right wheel support hold the chassis above ground level by at least the height of the chute subassembly;
wherein the front left wheel rotationally couples to the lower end of the front left wheel support;
wherein the front left wheel swivel around the lower end of the front left wheel support to allow easier steering of the mulch spreader;
wherein the rear left wheel rotationally couples to the lower end of the rear left wheel support;
wherein the front right wheel rotationally couples to the lower end of the front right wheel support;
wherein the front right wheel swivels around the lower end of the front right wheel support to allow easier steering of the mulch spreader;
wherein the rear right wheel rotationally couples to the lower end of the rear right wheel support;
wherein the upper end of the front left wheel support attaches to the chassis;
wherein the upper end of the rear left wheel support attaches to the chassis;
wherein the upper end of the front right wheel support attaches to the chassis;
wherein the upper end of the rear right wheel support attaches to the chassis.

14. The mulch spreader according to claim 13
wherein the chute subassembly comprises the bearing and the chute;
wherein the bearing connects to the bottom side of the chassis and surrounds the hole in the chassis;
wherein the chute is rotationally connected to the bearing;
wherein the chute rotates 360° around the bearing;
wherein the chute is a conduit for the mulch that is leaving the mulch hopper.

15. The mulch spreader according to claim 14
wherein the chute accepts attachments.

16. The mulch spreader according to claim 15
wherein the electrical subsystem comprises the rechargeable battery, a recharging port, recharging port wiring, battery wiring, the compressor motor, the compressor button, compressor button wiring, the chute motor, the chute rotation button, chute rotation button wiring and the air compressor;
wherein the rechargeable battery is a control that allows or disallows the flow of electrical current to the air compressor;
wherein when the compressor button is activated, electrical current flows from the rechargeable battery to the compressor motor causing the spindle of the compressor motor to turn;
wherein when the compressor button is deactivated, electrical current stops flowing from the rechargeable battery to the compressor motor and therefore the spindle of the compressor motor stops turning;
wherein the rechargeable battery comprises an energy storing device;
wherein the rechargeable battery provides an electrical potential difference to cause the energization of the chute motor and the compressor motor;
wherein the rechargeable battery provide the electrical potential difference until such time as the rechargeable battery becomes discharged, at which time the rechargeable battery will require recharging from an external power source;
wherein the recharging port comprises an electrical connector mounted on the mulch hopper in such a way that it is adapted to be accessible to an operator from the outside of the mulch hopper;
wherein the recharging port wiring comprises a set of wires that conduct electrical current from the recharging port to the rechargeable battery;
wherein the battery wiring comprises a set of wires that conduct electrical current from the rechargeable battery to the compressor button and to the chute rotation button.

17. The mulch spreader according to claim 16
wherein the compressor motor is mounted within the plenum and is coupled to the air compressor;
wherein when electrical energy is applied to the compressor motor the spindle of the compressor motor turns and causes the air compressor to move air from one or more air inlets to the one or more air outlets via the one or more air channels;
wherein the pressurized air pumped into the mulch hopper causes the mulch in the mulch hopper to loosen and thus be less likely to clog;
wherein when the trap door is closed and the removable cap has been removed, the flow of pressurized air out of the mulch hopper via the hose connection carries the mulch with it.

18. The mulch spreader according to claim 17
wherein the chute motor attaches to the bottom of the chassis;
where the chute motor is located in a position where it engages with the bearing.

19. The mulch spreader according to claim 81
wherein the air compressor is a mechanical air pump which sucks air in at the one or more air inlets, compresses the air, and expels pressurized air into the mulch hopper via the one or more air channels and the one or more air outlets.
